(19) United States
(12) Patent Application Publication
(10) Pub. No.: US 2006/0273658 A1
(43) Pub. Date: Dec. 7, 2006

(54) Method for restoring, stabilizing and maintaining the coefficient of friction of brakem linings

(76) Inventors: Georg Halassy-Wimmer, Markgroningen (DE); Paul Linhoff, Neu-Anspach (DE); Jochen Thiesing, Mainz-Kastel (DE); Christof Maron, Kelkheim (DE); Jurgen Volkel, Frankfurt am Main (DE)

Correspondence Address: Gerlinde M Nattler;Craig Hallacher, Continental Teves Inc, One Continental Drive, Auburn Hills, MI, 48326, US

(21) Appl. No.: 10/557,863

(22) PCT Filed: Mar. 18, 2004
(86) PCT No.: PCT/EP04/50843

§ 371 Date: Nov. 21, 2005

(30) Foreign Application Priority Data
May 19, 2003 (DE) 103 22 451.3

(51) Int. Cl. F16D 66/00

(52) U.S. Cl. 303/191; 188/1.11 E

(57) ABSTRACT

It has been shown that the effectiveness of the brake (3, 4) can be reduced not only due to external foreign materials on the brake linings, but also due to the coefficient of friction of a brake lining that can vary. This is the case, for example, when a brake lining is not yet worn in, when it exhibits tapered wear, or when its surface changes due to chemical influences. Influences of this type can alter the coefficient of friction of a brake lining by 20% and higher entailing, under certain circumstances, negative consequences during a possible brake operation. An object of the present device is to improve the coefficient of friction of a brake lining under certain conditions. This object is achieved by a program for improving the coefficient of friction of the brake lining that is initiated depending on a first parameter and is terminated depending on a second parameter. The program grinds or adapts the brake lining at appropriate locations by an automatically repeated braking, and in constantly measuring the prevailing coefficient of friction in an at least indirect manner.

### SUMMARY OF THE INVENTION

Whether an accident with a related damage occurs frequently depends on shortening the stopping distance by only very short distances. Apart from a number of other factors, it is therefore very important that the function of the brake system (e.g. service brake of a vehicle) is optimal. This applies also to brake operations which usually perform only a mere parking function such as the parking brake system of a vehicle or the blocking brake of a cabin of an elevator.

DE 19947903 A1 discloses that the effect of a brake can be improved for any possible future brake operation in such a fashion that the linings of the brake are dried by friction as a precaution. The same holds true with the precautionary removal of a layer of dirt on the lining or on the friction partner (e.g. the brake disc).

It has shown that not only external foreign materials on the brake linings can reduce the effect of the brake but that even the coefficient of friction of a brake lining itself can vary. This applies, for example, if a brake lining has not yet been worn in, if the lining exhibits tapered wear, or if it changes its surface due to chemical influences. Influences of this type can alter the coefficient of friction of a brake lining by 20% and higher and cause, under certain circumstances, negative consequences in a possible brake operation.

### BACKGROUND OF THE INVENTION

In view of the above, disclosed is a method for improving the coefficient of friction of brake linings of a friction brake of a vehicle or a cabin of an elevator. An object of the invention involves improving the coefficient of friction of a brake lining under defined conditions, leading to the nominal range of the coefficient of friction or leading back thereto. As this occurs, it is insignificant whether the brake system is a service brake system, a combined service and parking brake system, or a pure parking brake system.

This object is achieved by a method that automatically actuates a brake according to a predetermined program depending on a predetermined parameter and that terminates the program based on a second predetermined parameter. Thus, the invention principally resides in finding out whether a defined first condition (first parameter) has occurred, in taking certain predetermined measures (program) after determination of this first parameter and in terminating the program after determination of the second parameter.

An important factor which does not yet allow a brake lining to reach its optimal coefficient of friction is that the brake lining has not yet been worn in. Brake linings reach their operational coefficient of friction only after a wear-in process. Thus, the necessary clamping force/pressure for a defined deceleration increases until the operational coefficient of friction is reached. In this arrangement, the first parameter represents the commencement of the driving operation of a vehicle or an elevator cabin. However, the first parameter may also consist in equipping the vehicle or the cabin with new brake linings, i.e. in exchanging the brake linings.

This means that the program is switched on when the vehicle or the cabin has been equipped with new brake linings, irrespective of whether the brake linings of the original equipment are still new, or whether the brake linings have just been exchanged. An additional condition for the commencement of the first parameter can be that the vehicle or the cabin is moved so that the program is switched on as soon as the vehicle or the cabin moves for the first time or after new installation or exchange of the brake linings, what may be identified e.g. by way of the speedometer.

The second parameter can be defined as follows: the program runs

only for a defined time period, e.g. a maximum of two months after initiation of the vehicle or the cabin, and/or

within a defined distance/kilometer reading, e.g. >0 km start, 500 km end.

A combination of time/distance for deactivating the program is likewise possible for the determination of the second parameter. Activation or deactivation according to the above criteria can also be triggered after brake lining replacement. The identification of lining exchange and the type of the lining fitted in the exchange is possible by way of a coding on the brake lining or by an input at an appropriate control unit (ECU). The determination of the second parameter, the form of the program itself, and its termination can be input into the vehicle or into the elevator system by means of an online update according to manufacturer's regulations. This also allows inputting modifications for the program run and parameters based on up-to-date findings of the manufacturer (software update).

The second parameter and, hence, the deactivation of the system may even be triggered if a predefined relation between clamping force or pressure versus deceleration is reached (optional when deceleration sensors are provided). For deceleration purposes, it is also possible to use accelerometers or weighing cells (in an escalator), as they are employed in connection to controlled brake systems. Deactivation may possibly occur when a predefined relation between clamping force or pressure versus slope gradient or weight of elevator car/elevator cabin is detected in an electric parking brake (EPB). What is meant is that e.g. in parking brakes a defined clamping force or hydraulic pressure is adjusted depending on an angle of slope/weight in such a manner that the vehicle or the elevator cabin just refrains from starting to move. If there is a force in excess of the nominal value in this case, the coefficient of friction is not yet optimal. This method is particularly favorable when the vehicle is anyway equipped with a gradient sensor.

The third parameter restricts the start of the program in the presence of the first parameter to the following additional marginal conditions or influences the run of the program:
clamping force/brake pressure during the wear-in brake operation without any noticeable vehicle deceleration or elevator cabin deceleration occurring;
brake operations repeat cyclically according to a raster to be defined, e.g. every 5 minutes or every five kilometers during driving operations. By way of a counter (e.g. brake light switch as a trigger), the brake operations performed by the driver can also have an influence on the frequency of the run-in brake operations;
brake operations repeat during empty rides of the elevator cabin (with respect to the driving motor);
up to a defined speed, (e.g. <100 km/h as regards a vehicle or <10 m/s, preferably <5 m/s, as regards an elevator);
not during cornering maneuvers in the vehicle (optional when a steering angle sensor is provided);
not at temperatures of the friction pair>200° C. (detection e.g. by way of software temperature model or temperature sensor);
not during braking by the driver in the vehicle;
not during braking in manual operation or during an emergency braking in the elevator.

Another important factor which does not yet allow a brake lining to reach its optimal coefficient of friction is that the brake lining suffers from tapered wear. Due to tapered wear, the clamping travel or piston travel for a defined clamping force will increase, that means the characteristic curve of rigidity of the system becomes flatter.

It is possible to measure the first parameter that serves to initiate the program as follows: based on a characteristic curve of rigidity (clamping force/pressure in relation to piston travel) stored in the piston it is detected when the tapered wear recovery must be activated. As soon as the measured values correspond to the stored characteristic curve again, the second parameter is considered to prevail, and the program for the regeneration is completed. A new activation is possible any time in case the parameters do not correspond to the characteristic curve of rigidity.

The characteristic curve of rigidity can be detected due to possibly different lining compressibilities after brake lining exchange. Detection is executed by way of the coding on the brake lining or by manual input into a control unit. The online update described hereinabove is possible again.

The recovery of tapered wear takes place under the following marginal conditions:
clamping force/brake pressure for the recovery of tapered wear is chosen in such a way that no noticeable vehicle deceleration or elevator cabin deceleration occurs;
brake operations repeat cyclically according to a raster to be defined, e.g. every 5 minutes or every five kilometers during driving operations. By way of a counter (e.g. brake light switch as a trigger), the brake operations performed by the driver can also have an influence on the frequency of the tapered wear recovery;
up to a defined speed, the operation of the program is allowable, e.g. v<100 km/h or v<10 m/s, preferably v<5 m/s;
no automatic braking during cornering maneuvers in the vehicle (optional when a steering angle sensor is provided);
no automatic braking at friction temperatures>200° C. (detection e.g. by way of a software temperature model or a sensor);
not during braking by the driver (vehicle);
not during braking in manual operation (elevator);
not if the brake linings are worn out (optional when a travel sensor or a lining wear indicator is provided).

An additional important factor which does not allow a brake lining to reach its optimal coefficient of friction is that due to an insufficient use of the brake system, the brake lining no longer reaches its operational coefficient of friction (the linings ‘becoming glass-like’, ‘becoming numb’). This occurs due to chemical processes on the surface of the lining. As this occurs, the necessary clamping force or pressure for a defined deceleration increases.

The first parameter initiating the program and the second parameter closing the program can be determined as follows. A characteristic curve ‘clamping force in relation to deceleration or weight’ which is stored in the system allows detecting when the brake linings need to be regenerated because a lining became ‘numb’. When the measured values clamping force/pressure in relation to deceleration correspond again to the stored characteristic curve, the second parameter is considered to prevail, and the regeneration is completed. Activation of the program is also possible when the stored characteristic curve (clamping force or pressure in relation to slope gradient) is not complied with upon actuation of an electric parking brake (EPB). This has been explained already hereinabove. A deactivation of the program occurs when the measured values correspond again to the characteristic curve in the EPB actuation. A new activation of the program is possible again at any time when the measured actual values are not in conformity with the characteristic curve. After a brake lining exchange due to possibly different lining coefficients of friction, the characteristic curve is updated (identification by way of coding on the brake lining, online update or separate input into the control unit as described hereinabove).

The regeneration of brake linings takes place under the following marginal conditions (third parameter or program):
clamping force/brake pressure during regenerative braking without any noticeable vehicle deceleration or elevator cabin deceleration occurring;
brake operations repeat cyclically according to a raster to be defined, e.g. every 5 minutes or every five kilometers during driving operations. By way of a counter (e.g. brake light switch as a trigger), the brake operations performed by the driver can also have an influence on the frequency of the regenerative brake operations;
up to a defined speed, e.g. v<100 km/h (in vehicles) or v<10 m/s, preferably v<5 m/s (in elevators);
not during cornering maneuvers (optional when a steering angle sensor is provided);
not at friction temperatures>200° C. (detection e.g. by way of a software temperature model;
not during braking by the driver (inclusive manual operation and emergency or safety braking in an elevator);
not if the brake linings are worn out (optional when a clamping travel sensor or a lining wear indicator is provided).

### BRIEF DESCRIPTION OF THE DRAWINGS

FIG. 1 shows a block wiring diagram typical of a vehicle for the course of the method of the invention related to the wear-in of brake linings;

FIG. 2 shows a block wiring diagram typical of a vehicle for the course of the method of the invention related to the recovery of tapered wear of brake linings, and

FIG. 3 shows a block wiring diagram typical of a vehicle for the course of the method of the invention related to the regeneration of glass-like brake linings.

### DETAILED DESCRIPTION OF THE DRAWINGS

In the elevator operation it is possible to install fewer or more brakes than the four brakes shown herein.

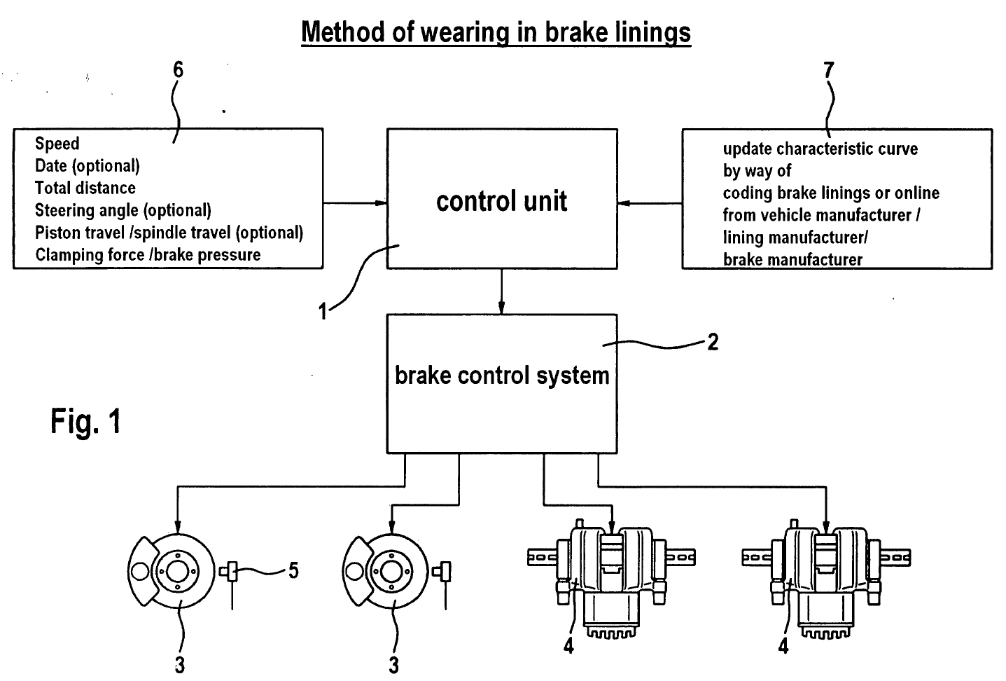

FIG. 1 shows a control unit 1 into which the measured parameters are input and which will then actuate a brake control system 2 for implementing the method of the invention. The brake control system 2 is used to automatically actuate brakes 3 on the front wheels or brakes 4 on the rear wheels of a vehicle, with the result that the coefficient of friction of the brake linings is improved, as has been described in the above. The brakes can be equipped with detectors 5 for measuring the driving speed of the vehicle, and they can be driven hydraulically (brakes 3) or by an electric force (brakes 4). A measurement unit 6 can supply the control unit 1 with appropriate measured values which are indicated in FIG. 1 and from which the first and the third parameters are derived. A data generator 7 furnishes the control unit 1 with data originating from the vehicle manufacturer or the manufacturer of the brake linings.

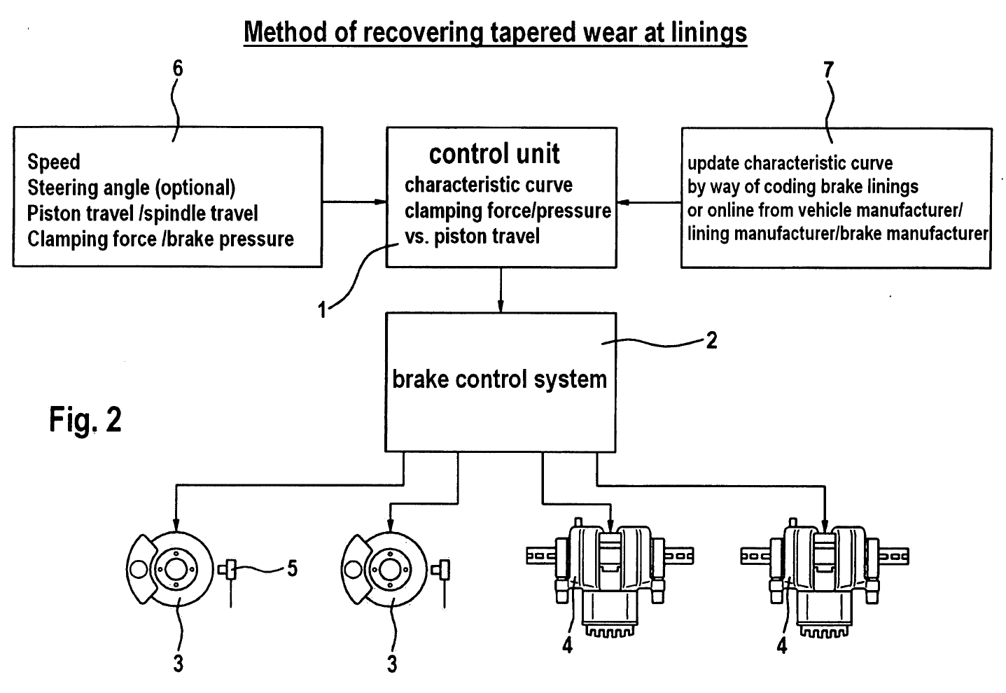

FIG. 2 similarly describes a method for the recovery of tapered wear of brake linings. The difference compared to the method of FIG. 1 resides in that this method is not required with new brake linings and, accordingly, the need for measuring the date and/or the distance is obviated. Further, the control unit stores characteristic curves which describe the clamping force or the pressure as a function of the piston travel.

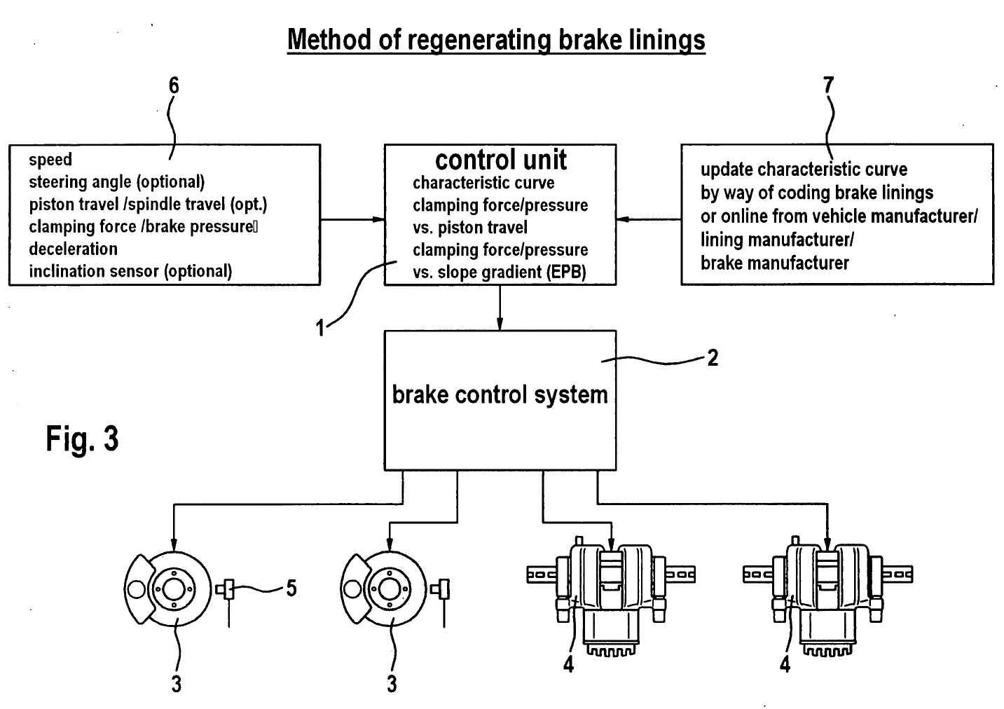

FIG. 3 similarly describes a method for the regeneration of glass-like brake linings. The difference compared to the method of FIG. 1 resides in that the control unit stores characteristic curves which describe the clamping force or the pressure as a function of the piston travel, or describe the clamping force or the pressure as a function of the slope gradient (in the vehicle) or the weight (as regards the elevator).

1-7. (canceled)

8. A method of improving a coefficient of friction of brake linings of a friction brake (3, 4) of a vehicle or a cabin of an elevator, the method comprising:
automatically actuating the brake (3, 4) according to a predetermined program depending on a predetermined first parameter (6), in particular a first measured value; and
terminating the program depending on a predetermined second parameter (6), preferably a second measured value, wherein the brake is automatically actuated in intervals.

9. The method according to claim 8, wherein for wear-in of the brake linings the first parameter represents the initiation of the vehicle or the cabin of the elevator or the brake lining exchange, and in that the second parameter represents a predetermined time period and/or a predetermined distance covered by the vehicle or the elevator cabin, and the predetermined values are measured starting from the occurrence of the first parameter.

10. The method according to claim 8, wherein in order to recover tapered wear of brake linings, the first parameter is determined by a drop in rigidity of the brake below a predetermined first nominal value, and the second parameter is determined by the rigidity exceeding a second nominal value, and preferably the first nominal value is in conformity with the second nominal value.

11. The method according to claim 10, wherein the rigidity is determined indirectly by the clamping travel in the brake caliper that is required for a defined clamping force or pressure.

12. The method according to claim 8, wherein in order to regenerate the coefficient of friction of brake linings with a reduced coefficient of friction, the first parameter is determined by the drop of the deceleration of the vehicle below a predetermined first nominal value at a predetermined clamping force or pressure of the brake, and the second parameter is determined by the deceleration exceeding a second nominal value at a predetermined clamping force or pressure, and preferably the first nominal value is in conformity with the second nominal value.

13. The method according to claim 8, wherein a third parameter is provided, the presence of which prevents the start of the program when the first parameter appears.

14. The method according to claim 13, wherein the third parameter is a measured value.
